(19) United States
(12) Patent Application Publication
(10) Pub. No.: US 2023/0142191 A1
(43) Pub. Date: May 11, 2023

(54) Electronic Animal Collar Assembly

(71) Applicant: Darlene Sanchez, Austin, TX (US)

(72) Inventor: Darlene Sanchez, Austin, TX (US)

(21) Appl. No.: 17/521,992

(22) Filed: Nov. 9, 2021

(51) Int. Cl. A01K 27/00; A01K 15/02; A01K 11/00

(52) U.S. Cl. CPC A01K 27/009; A01K 15/023; A01K 11/008; A01K 27/001

(57) ABSTRACT

An electronic animal collar assembly for tracking, confining, and training an animal includes a collar, which is securable around a neck of an animal, such as a canine. An electronics module comprising a transceiver, a stimulator, and a receiver is engaged to the collar. The transceiver is Global Positioning System enabled. Programming code is selectively positionable on an electronic device, such as a cellphone of a user, enabling communication with and control of the electronics module to selectively track the animal, using the transceiver, and to selectively confine and correct the animal using the stimulator and one or both of the transceiver and the receiver.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to animal collar assemblies and more particularly pertains to a new animal collar assembly for tracking, confining, and training an animal. The present invention discloses an animal collar assembly comprising a collar in communication with and under control of an electronic device, such as a cellphone, by means of programming code positioned on the electronic device, which allows tracking the dog using GPS transceiver, setting of a virtual perimeter, and training of the animal via a stimulator

### (2) Description of Related Art Including Information Disclosed Under 37 CFR 1.97 and 1.98

The prior art relates to animal collar assemblies. Prior art animal collar assemblies may comprise one or more of GPS transceivers, cameras, stimulators, radios, receivers, lights, and speakers. What is lacking in the prior art is an animal collar assembly comprising a collar in communication with and under control of an electronic device, such as a cellphone, by means of programming code positioned on the electronic device, which allows tracking the dog using a GPS transceiver, setting of a virtual perimeter, and training of the animal via a stimulator.

### BRIEF SUMMARY OF THE INVENTION

An embodiment of the disclosure meets the needs presented above by generally comprising a collar, which is configured to be secured around a neck of an animal, such as a canine. An electronics module comprising a transceiver, a stimulator, and a receiver is engaged to the collar. The transceiver is Global Positioning System enabled. Programming code is selectively positionable on an electronic device, such as a cellphone of a user, enabling communication with and control of the electronics module to selectively track the animal, using the transceiver, and to selectively confine and correct the animal using the stimulator and one or both of the transceiver and the receiver.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an electronic animal collar assembly according to an embodiment of the disclosure.

FIG. 2 is a rear view of an embodiment of the disclosure.

FIG. 3 is a side view of an embodiment of the disclosure.

FIG. 4 is a front view of an embodiment of the disclosure.

FIG. 5 is a cross-sectional view of an embodiment of the disclosure.

FIG. 6 is a block diagram of an embodiment of the disclosure.

FIG. 7 is an in-use view of an embodiment of the disclosure.

### DETAILED DESCRIPTION OF THE INVENTION

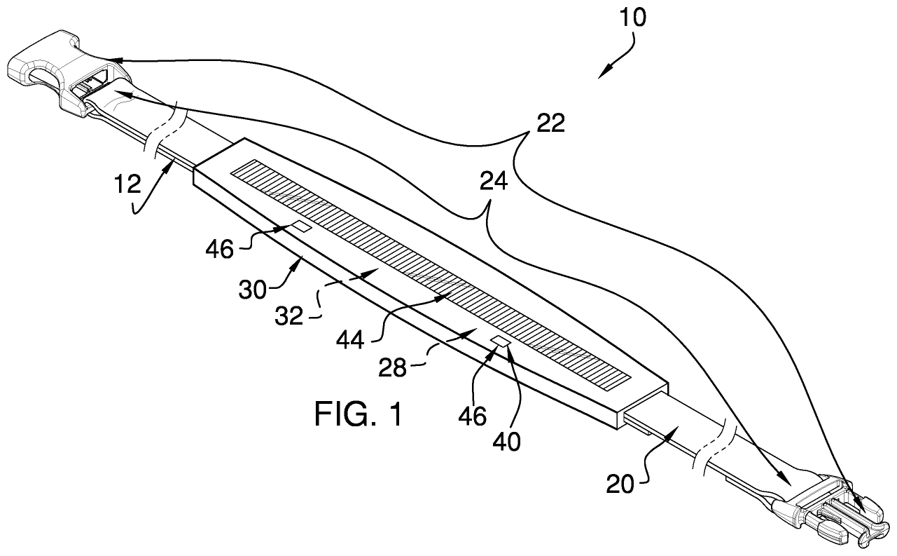

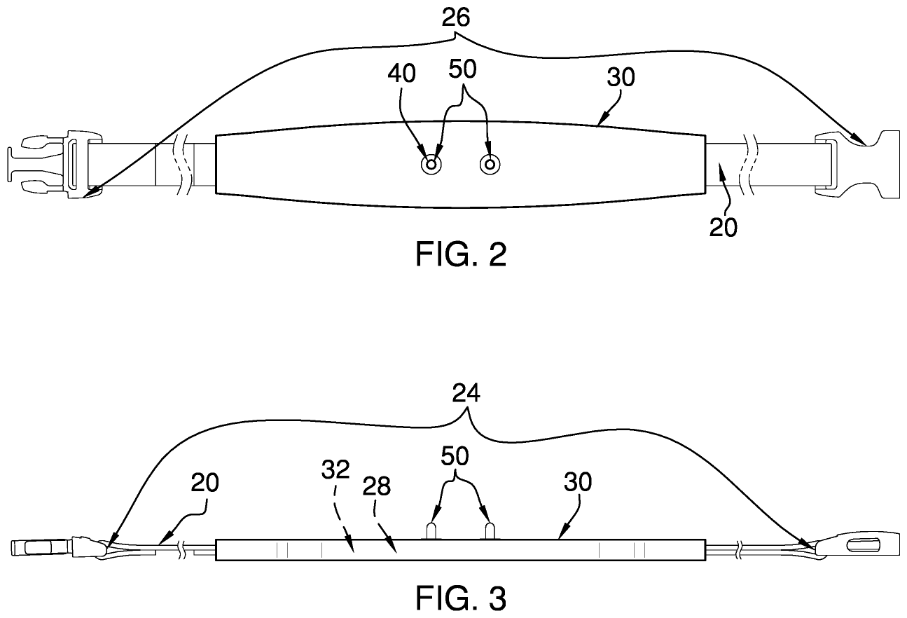

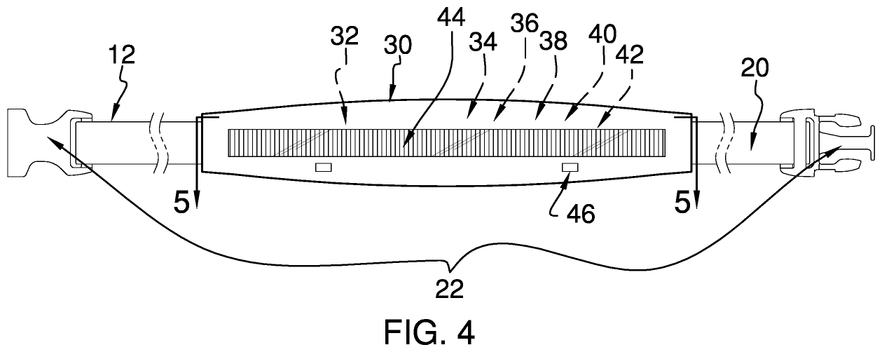

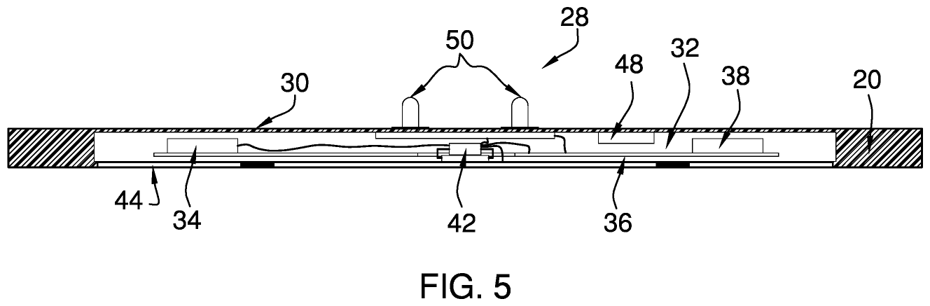

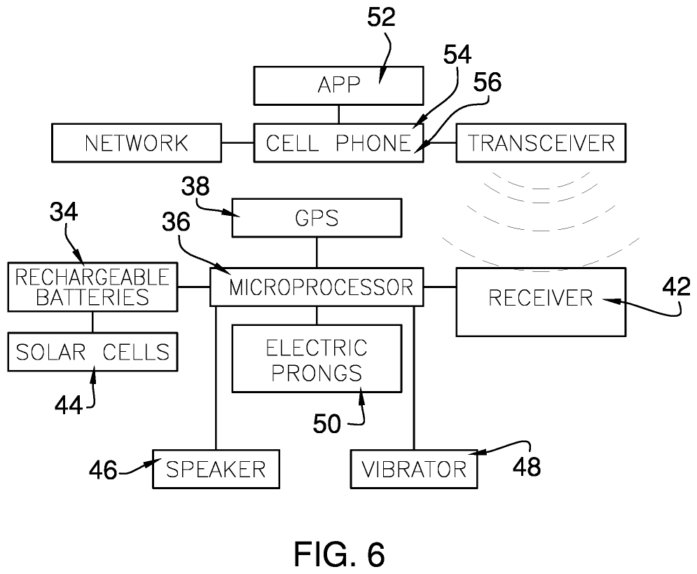

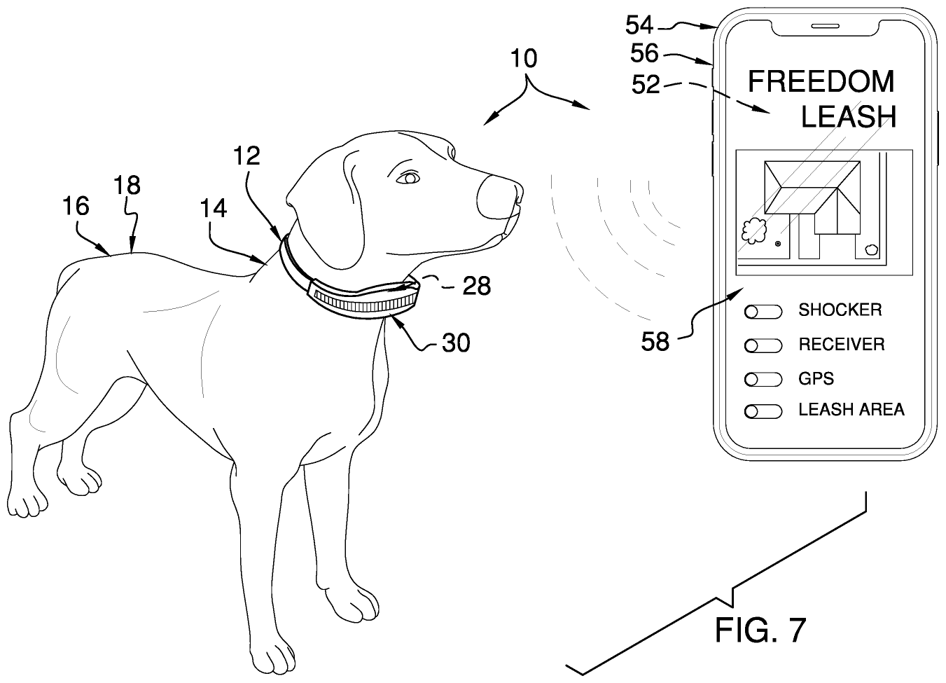

With reference now to the drawings, and in particular to FIGS. 1 through 7 thereof, a new animal collar assembly embodying the principles and concepts of an embodiment of the disclosure and generally designated by the reference numeral 10 will be described.

As best illustrated in FIGS. 1 through 7, the electronic animal collar assembly 10 generally comprises a collar 12, which is configured to be secured around a neck 14 of an animal 16, such as a canine 18. The collar 12 comprises a strap 20 and a pair of connectors 22, which are engaged singly to opposed ends 24 of the strap 20. The connectors 22 are selectively mutually couplable to secure the collar 12 around the neck 14 of the animal 16. The pair of connectors 22 may comprise a side release buckle 26, or other connecting means, such as, but not limited to, traditional buckles and the like. The present invention also anticipates the collar 12 being of other types, such as, but not limited to, Martindale collars, head collars, harnesses, and the like.

An electronics module 28 is engaged to the collar 12. The electronics module 28 comprises a housing 30, which defines an interior space 32. The housing 30 comprises one or more of rubber, silicone, and elastomer so that the housing 30 is resiliently flexible. A battery 34, a microprocessor 36, a transceiver 38, a stimulator 40, and a receiver 42 are engaged to the housing 30 and are positioned in the interior space 32. The microprocessor 36 is operationally engaged to the battery 34, the transceiver 38, the stimulator 40, and the receiver 42. The transceiver 38 is Global Positioning System enabled.

The battery 34 is rechargeable. A solar panel 44 is engaged to the housing 30 and is operationally engaged to the battery 34. The solar panel 44 is configured to convert electromagnetic radiation to an electrical current to charge the battery 34. The present invention also anticipates the battery 34 being chargeable by means of a charging cord (not shown).

The stimulator 40 comprises at least one of a speaker 46, a vibrator 48, and a pair of prongs 50. The microprocessor 36 can selectively actuate the speaker 46, the vibrator 48, and the pair of prongs 50 to deliver an audible signal, a vibratory signal, and a shock correction, respectively, to the animal 16.

Programming code 52 is selectively positionable on an electronic device 54, such as a cellphone 56 of a user. The programming code 52 enables communication with and control of the electronics module 28 to selectively track the animal 16, using the transceiver 38, and to selectively confine and to correct the animal 16 using the stimulator 40 and one or both of the transceiver 38 and the receiver 42. The programming code 52 may emulate a control screen 58 on the electronic device 54, as shown in FIG. 7. The present invention anticipates a variety of functions being enabled by the programming code 52, such as, but not limited to, selectively actuating the transceiver 38, receiver 42, and stimulator 40, and setting a virtual perimeter to confine the animal 16.

In use, the collar 12 is secured around the neck 14 of the animal 16 and the programming code 52 is positioned on the electronic device 54. The programming code 52 enables communication between the electronic device 54 and the electronics module 28, allowing the user to selectively track the animal 16 using the transceiver 38. The user also can selectively confine the animal 16 by setting the virtual perimeter using the programming code 52. As the animal 16 approaches the virtual perimeter, it might receive an audible signal or a vibratory signal. Should the animal 16 breach the virtual perimeter, it might receive a shock correction. The user also can selectively correct the animal 16 for training purposes using the stimulator 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electronic animal collar assembly comprising:
a collar configured for securing around a neck of an animal;
an electronics module engaged to the collar, the electronics module comprising a transceiver, a stimulator, and a receiver, the transceiver being Global Positioning System enabled; and
programming code selectively positionable on an electronic device enabling communication with and control of the electronics module for selectively tracking the animal using the transceiver and for selectively confining and correcting the animal using the stimulator and one or both of the transceiver and the receiver.

2. The electronic animal collar assembly of claim 1, wherein the collar comprises:
a strap; and
a pair of connectors engaged singly to opposed ends of the strap, the connectors being selectively mutually couplable for securing the collar around the neck of the animal.

3. The electronic animal collar assembly of claim 2, wherein the pair of connectors comprises a side release buckle.

4. The electronic animal collar assembly of claim 1, further including the electronics module comprising:
a housing defining an interior space, the transceiver, the stimulator, and the receiver being engaged to the housing and positioned in the interior space;
a battery engaged to the housing and positioned in the interior space, a microprocessor engaged to the housing and positioned in the interior space, the microprocessor being operationally engaged to the battery, the transceiver, the stimulator, and the receiver; and
the stimulator comprising at least one of a speaker, a vibrator, and a pair of prongs, positioning the microprocessor for selectively actuating the speaker, the vibrator, and the pair of prongs for delivering an audible signal, a vibratory signal, and a shock correction, respectively, to the animal.

5. The electronic animal collar assembly of claim 4, wherein the housing comprises one or more of rubber, silicone, and elastomer, such that the housing is resiliently flexible.

6. The electronic animal collar assembly of claim 4, further including:
the battery being rechargeable; and
a solar panel engaged to the housing and operationally engaged to the battery, wherein the solar panel is configured for converting electromagnetic radiation to an electrical current for charging the battery.

7. An electronic animal collar system comprising:
a collar secured around a neck of an animal;
an electronics module engaged to the collar, the electronics module comprising a transceiver, a stimulator, and a receiver, the transceiver being Global Positioning System enabled;
an electronic device; and
programming code positioned on the electronic device enabling communication with and control of the electronics module for selectively tracking the animal using the transceiver and for selectively confining and correcting the animal using the stimulator and one or both of the transceiver and the receiver.

8. The electronic animal collar system of claim 7, wherein the electronic device comprises a cellphone.

9. The electronic animal collar system of claim 7, wherein the animal comprises a canine.

10. An electronic animal collar assembly comprising:
a collar configured for securing around a neck of an animal, the collar comprising:
a strap, and
a pair of connectors engaged singly to opposed ends of the strap, the connectors being selectively mutually couplable for securing the collar around the neck of the animal, the pair of connectors comprising a side release buckle;
an electronics module engaged to the collar, the electronics module comprising a transceiver, a stimulator, and a receiver, the transceiver being Global Positioning System enabled, the electronics module comprising:
a housing defining an interior space, the transceiver, the stimulator, and the receiver being engaged to the housing and positioned in the interior space, the housing comprising one or more of rubber, silicone, and elastomer, such that the housing is resiliently flexible,
a battery engaged to the housing and positioned in the interior space, the battery being rechargeable,
a solar panel engaged to the housing and operationally engaged to the battery, wherein the solar panel is configured for converting electromagnetic radiation to an electrical current for charging the battery,
a microprocessor engaged to the housing and positioned in the interior space, the microprocessor being operationally engaged to the battery, the transceiver, the stimulator, and the receiver, and
the stimulator comprising at least one of a speaker, a vibrator, and a pair of prongs, positioning the microprocessor for selectively actuating the speaker, the vibrator, and the pair of prongs for delivering an audible signal, a vibratory signal, and a shock correction, respectively, to the animal; and
programming code selectively positionable on an electronic device enabling communication with and control of the electronics module for selectively tracking the animal using the transceiver and for selectively confining and correcting the animal using the stimulator and one or both of the transceiver and the receiver.
